(19) United States
(12) Patent Application Publication
(10) Pub. No.: US 2018/0194027 A1
(43) Pub. Date: Jul. 12, 2018

(54) DISPOSABLE SHAVER SYSTEM AND METHOD

(71) Applicants: Ron Tews, Alpena, MI (US); Patti Tews, Alpena, MI (US)

(72) Inventors: Ron Tews, Alpena, MI (US); Patti Tews, Alpena, MI (US)

(21) Appl. No.: 15/836,585

(22) Filed: Dec. 8, 2017

Related U.S. Application Data
(60) Provisional application No. 62/443,644, filed on Jan. 6, 2017.

(51) Int. Cl. B26B 21/44; B26B 21/40; B26B 21/06; B26B 21/52

(52) U.S. Cl. CPC B26B 21/446; B26B 21/521; B26B 21/06; B26B 21/4081

(57) ABSTRACT

A disposable shaver system includes a shaver-body having a handle including an outer-surface and an inner-volume, a shaver-head, having an integral blade retainer and at least one cutting blade, a dispensing assembly having a dispensing valve and a handle closure cap. The disposable shaver assembly includes the shaver-body, shaver-body, handle, shaver-head, dispensing assembly, and a handle closure cap configured to provide a compact disposable shaving system allowing a user to shave using the at least one cutting blade and dispense the contents as needed for shaving.

### CROSS-REFERENCE TO RELATED APPLICATION(S)

The present application is related to and claims priority to U.S. Provisional Patent Application No. 62/443,644 filed Jan. 6, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of disposable razors of existing art and more specifically relates to a disposable razor with a shaving cream dispenser.

### RELATED ART

Many individuals use razors. With a conventional disposable hand razor, a razor blade is mounted in a shaving head portion of the hand razor that is carried on an end of a handle, with the handle being grasped by the shaver during shaving. During the shaving operation, the shaver conventionally applies lather-forming shaving lubricant to a body portion, such as the face, to be shaved. The lathers, creams, gels and the like, are applied to the face or body portions, and are typically supplied in large, relatively heavy multiple serving plastic and/or metallic containers. These large containers are suitable for home use.

When traveling it is often desirable to shave before an important meeting or social occasion. It is inconvenient for most individuals to carry a separate shaver and shaving cream dispenser both before and after use. The cans are typically bulky and difficult to store, especially where luggage space is limited. Cans and lotion bottles can leak in the luggage, especially at low pressure in airplane baggage compartments. Thus, it makes little sense to carry the razor, and shaving lubricant can on a short trip. A suitable solution is desired.

U.S. Pat. No. 7,788,809 to Louis D. Tomassetti relates to a disposable razor with integrated shaving cream dispenser. The described disposable razor with integrated shaving cream dispenser includes a disposable safety razor having an integral shaving conditioner dispenser includes a neck to which a blade cartridge is affixed at a top end thereof and a handle extends downwardly therefrom. The handle is ergonomically shaped and has an exterior wall that defines a pressure cavity therein for receiving a shaving conditioning compound and a pressurized dispensing gas. The handle has an opening at its bottom and a valve received in the opening. The valve is configured to dispense the shaving conditioning compound downwardly through the valve with the razor held upright. A dispensing cap covers the valve and is engaged therewith such that movement of the dispensing cap causes release of the shaving conditioning compound downwardly through the valve and out from a discharge opening in the cap while holding the razor upright with the blade cartridge and neck positioned higher than the handle bottom and dispensing cap.

### SUMMARY OF THE INVENTION

In view of the foregoing disadvantages inherent in the known disposable razor art, the present disclosure provides a novel disposable shaver system. The general purpose of the present disclosure, which will be described subsequently in greater detail, is to provide a disposable shaver system efficient for travel use.

A disposable shaver system is disclosed herein. The disposable shaver system includes a shaver-body having a handle (including an outer-surface and an inner-volume), a shaver-head, having an integral blade retainer and at least one cutting blade, and a dispensing assembly having a dispensing valve and a handle closure cap. The disposable shaver system comprises the disposable shaver assembly as such; the disposable shaver assembly includes the shaver-body, handle, shaver-head, dispensing assembly, and the handle closure cap.

The handle is defined by the outer-surface and the inner-volume. The shaver-head includes the integral blade retainer and at least one cutting blade in functional combination. The dispensing assembly comprises the dispensing valve and the handle closure cap is removably couplable to the handle to provide access to the dispensing valve when it is desired to dispense contents held within the dispensing assembly. At least one cutting blade is mounted in the integral blade retainer and the dispensing assembly is contained within confines of the inner-volume of the handle wherein the disposable shaver system is configured to provide a compact disposable shaving system allowing a user to shave using at least one cutting blade and dispense the contents as needed for shaving.

According to another embodiment, a method of use for a disposable shaver system is also disclosed herein. The method of use for a disposable shaver system includes providing a disposable shaver assembly, removing a handle closure cap, dispensing contents and disposing of the disposable shaver assembly

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a disposable shaver system, constructed and operative according to the teachings of the present disclosure.

FIG. 1 is a perspective view of the disposable shaver system during an ‘in-use’ condition, according to an embodiment of the disclosure.

FIG. 2 is a side view of the disposable shaver system of FIG. 1, according to an embodiment of the present disclosure.

FIG. 3 is a front view of the disposable shaver system of FIG. 1, according to an embodiment of the present disclosure.

FIG. 4 is a bottom view of the disposable shaver system of FIG. 1, according to an embodiment of the present disclosure.

FIG. 5 is a flow diagram illustrating a method of use for the disposable shaver system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a disposable razor with a shaving cream dispenser and more particularly to a disposable shaver system as used to improve the means for efficient shaving during travel/home use.

Generally, the present invention provides a means for efficient shaving use on a short trip to the local gym or a longer trip, such as an out of town business trip. It comprises both a razor and a pressurized container of shave cream items packaged together as one and available in different sized amounts of shaving cream in the handle of a disposable razor. Moreover, the device takes into account current airline travel restrictions imposed by the Transportation Safety Administration (TSA) which limit the size of containers that can be packed in carry-on luggage. The smaller ounce sizes may be comfortable in the user's hand while shaving. Thus, smaller containers 3.4 ounces or less for shaving creams, lotions and gels are much more desirable for travel purposes and have been increasing in popularity, particularly among frequent travelers. Additionally, not having to search in a travel bag for your razor and can of shaving cream saves time and space in a carry-on bag because it is one smaller item. The device is disposable; ideal for travel, camping, any time the user is away from home.

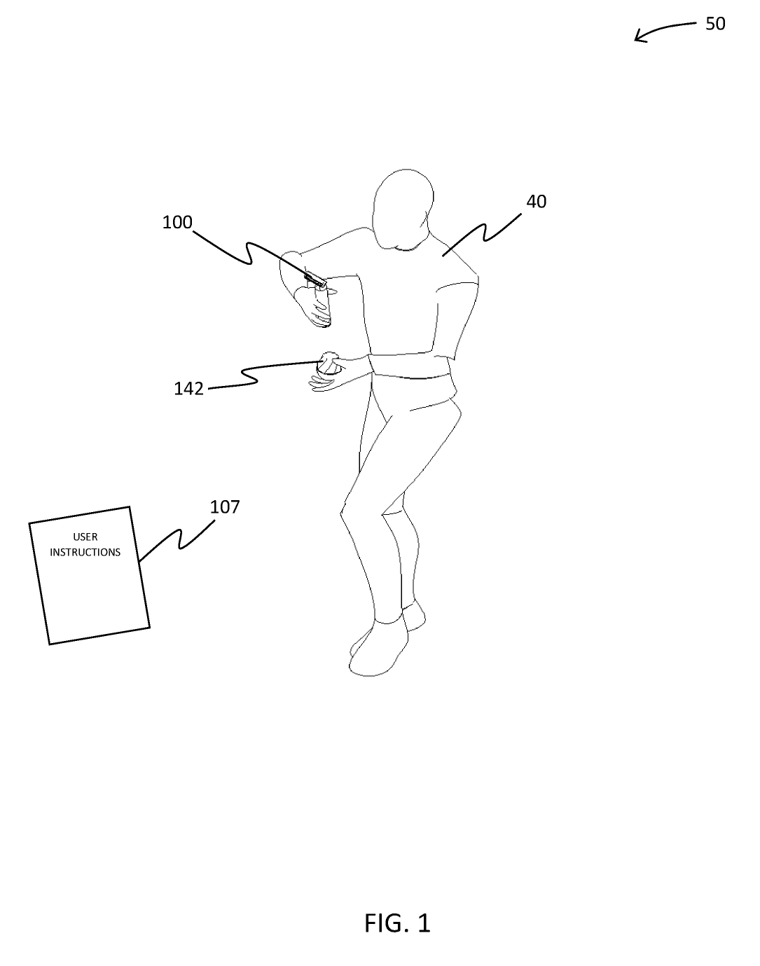

Referring now more specifically to the drawings by numerals of reference, there is shown in FIGS. 1-4, various views of a disposable shaver system 100.

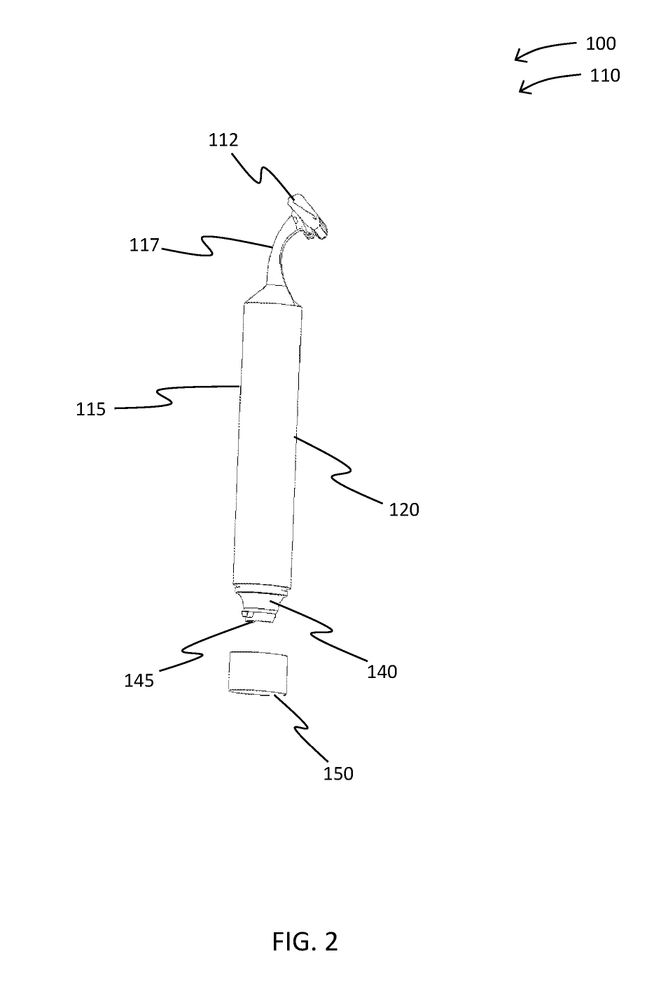

FIG. 1 shows a disposable shaver system 100 during an ‘in-use’ condition 50, according to an embodiment of the present disclosure. Here, the disposable shaver system 100 may be beneficial for use by a user 40 to provide a compact disposable shaving system 100 allowing a user 40 to shave using at least one cutting blade 135 and dispense contents 142 as needed for shaving that may also meet federal airline safety regulations. As illustrated, the disposable shaver system 100 may include a shaver-body 110, having a handle 115, including an outer-surface 120, an inner-volume 125, a shaver-head having an integral blade retainer 130 and at least one cutting blade 135. A dispensing assembly 140, having a dispensing valve 145, a handle 115 and a closure cap 150 shown in greater detail in FIGS. 2-4.

As shown in FIG. 1 during an ‘in-use’ condition 50 a user 40 may use the disposable shaver system 100 by removing the handle closure cap 150 and by holding the shaver-body 110 in one hand and dispensing the 142 stored within the inner-volume. The contents 142 may comprise shaving cream therein and may be dispensed therefrom via the dispensing valve 145 into the users 40 free hand to be applied to the skin area to be shaved. The user 40 may then invert the disposable shaver system 100 and use the shaver-head having an integral blade retainer 130 and at least one cutting blade 135 to provide a disposable shaving system allowing a user 40 to shave using at least one cutting blade 135 and dispense contents 142 as needed for shaving.

Upon completion of shaving, the user 40 may dispose of the disposable shaver system or may choose to replace the handle closure cap 150 and store for later use. Although not illustrated, it should be noted that in an embodiment of the disposable shaver system 100 the handle closure cap 150 may also be configured to provide a standing base for the disposable shaver system 100 such that it may be stored on a flat surface such as for example a vanity or shelf in an upright position to aid in the prevention of contamination of the integral blade retainer 130 and at least one cutting blade.

According to one embodiment, the disposable shaver system 100 may be arranged as a kit 105. In particular, the disposable shaver system 100 may further include a set of instructions 107. The instructions 107 may detail functional relationships in relation to the structure of the disposable shaver system 100 such that the disposable shaver system 100 can be used, maintained, or the like, in a preferred manner.

Referring now to FIG. 2 showing the disposable shaver system of FIG. 1, according to an embodiment of the present disclosure. As above, the disposable shaver system 100 may include a shaver-body 110, having a handle 115, including an outer-surface 120, an inner-volume 125, a shaver-head having an integral blade retainer 130 and at least one cutting blade 135. A dispensing assembly 140 having a dispensing valve 145, a handle 115 and a handle closure cap 150. The disposable shaver system comprises a disposable shaver assembly 140. The assembly 140 may include shaver-body 110. The shaver-body 110 may include a handle 115. The handle 115 may be tubular in shape (or other) defined by an outer-surface 120 and an inner-volume 125 and may further include a shaver-head and dispensing assembly 140. The dispensing assembly 140 may also be removable and refillable and the dispensing assembly 140 may be contained within confines of the inner-volume 125 of the handle.

According to one embodiment, the dispensing assembly 140 may comprise a 3-D cylindrical bottle 153. The dispensing assembly 140 may be sized to store a volume of up to 3.4 fluid ounces or less of the contents 142. Respectively, the fluid ounces of the contents 142 meet federal airline safety regulations. Although other embodiments may be envisioned containing fluid ounce volumes greater than 3.4 fluid ounces not intended for airline travel. Further, the handle closure cap 150 may be removably couplable and may be non-threadably-mountable to the handle 115 to provide access to the dispensing assembly 140 when it is desired to dispense contents 142 held within the dispensing assembly 140. The handle closure cap 150 may also provide security to prevent unintended dispensing of contents 142 or contamination when not in-use.

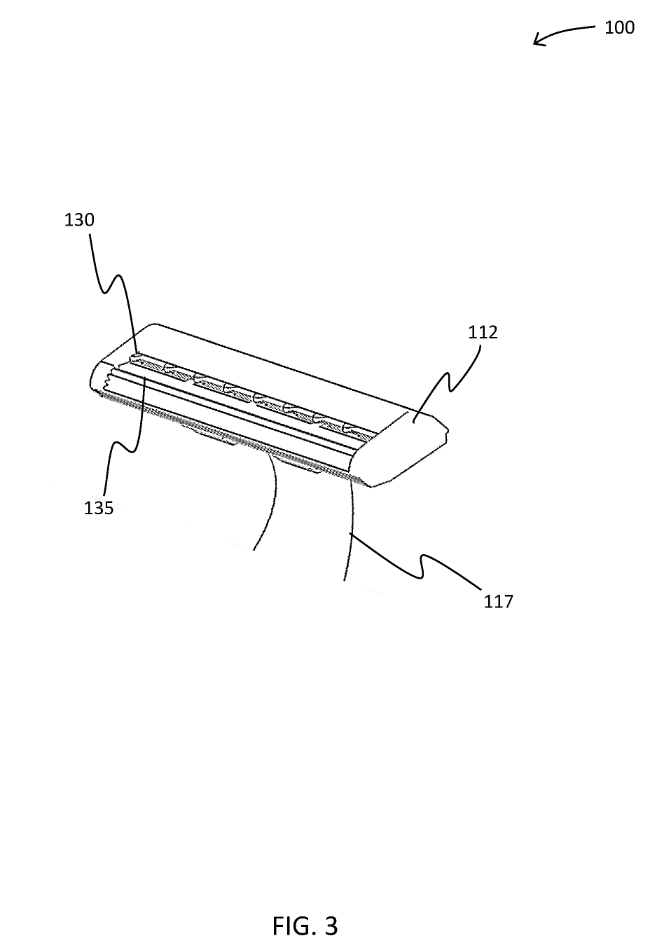

Additionally, the shaver-head may be integral to the shaver-body 110 and include an integral blade retainer 130. At least one cutting blade 135 may be mounted in the integral blade retainer 130 in functional combination as shown in FIG. 3. The shaver-head may also include arcuate neck extension 117 fixed to the main shaver-body 110 section for improved ergonomics. The disposable shaver system is configured to provide a compact disposable shaving system allowing a user 40 to shave using the at least one cutting blade 135 and dispense the contents 142 as needed for shaving.

FIG. 3 is a top view of the disposable shaver system 100 of FIG. 1, according to an embodiment of the present disclosure. As illustrated here, the shaver-head is integral with and fixed to the handle 115 via an arcuate neck extension 117 and further includes an integral blade retainer 130. At least one cutting blade 135 may be mounted in the integral blade retainer 130 in functional combination. Other embodiments may include a plurality of cutting blades 135 and the shaver-head may be hingeably-mounted. In yet another embodiment, the shaver-head may also include a shield or guard and at least one cutting blade 135 may be able to be lubricated via a lubricating strip adjacent to the cutting blade 135.

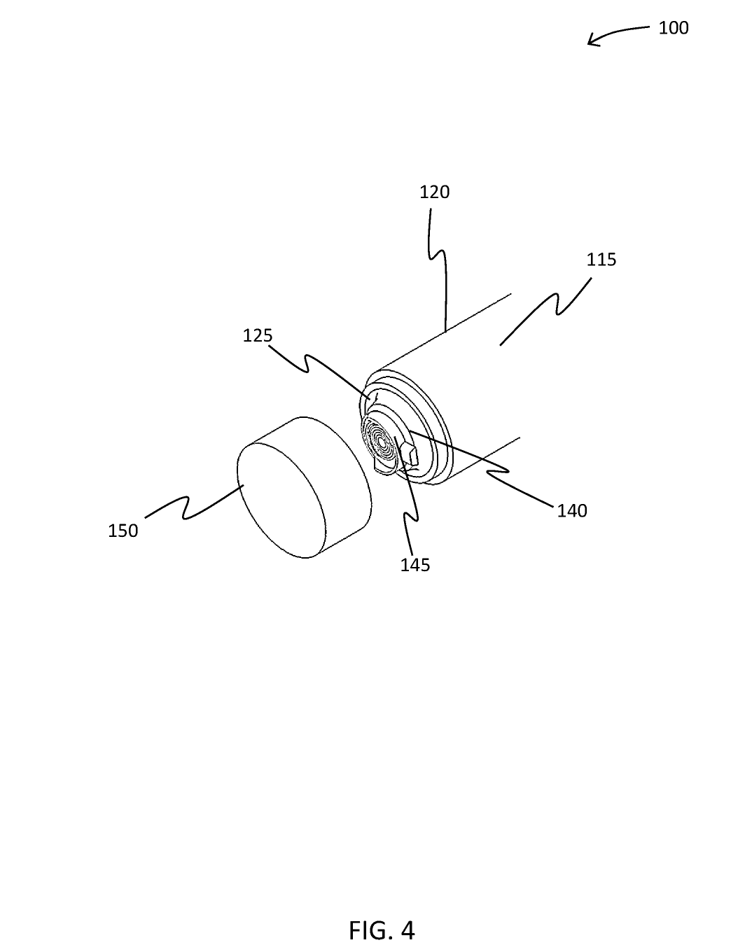

FIG. 4 is a bottom view of the disposable shaver system of FIG. 1, according to an embodiment of the present disclosure. As above, the disposable shaver system comprises a disposable shaver assembly 140. The assembly 140 may include shaver-body 110. The shaver-body 110 may include a handle 115. The handle 115 may be tubular in shape, defined by an outer-surface 120 and an inner-volume 125. The handle 115 may be configured to store a dispensing assembly 140 within the inner-volume 125 and may further include a handle closure cap 150. The handle closure cap 150 may be non-threadably-mountable as shown and is removable. Although in an embodiment of the present discloser, the handle closure cap 150 may respectively be threadably-coupleable. Furthermore, as stated in FIG. 1, the handle closure cap 150 may also be configured to provide a standing base for the disposable shaver system 100 such that it may be stored on a flat surface, in an upright position to aid in the prevention of contamination of the integral blade retainer 130 and at least one cutting blade. The handle closure cap 150 may also provide security to prevent unintended dispensing of contents 142 or contamination of the dispensing assembly 140 when not in-use as stated in FIG. 2.

Referring now more specifically to the inner-volume 125 configured to store a dispensing assembly 140. According to an embodiment of the present disclosure the dispensing assembly 140 is configured to store contents 142 comprising shaving liquid, cream or gel therein and to dispense therefrom via the dispensing valve 145 is non-removable and non-refillable. The dispensing valve 145 comprises a manual pump to dispense the contents 142.

According to another embodiment of the present disclosure the dispensing assembly 140 may be configured to store contents 142 comprising shaving liquid, cream or gel therein and to dispense therefrom via the dispensing valve 145; wherein the dispensing assembly 140 comprises a 3-D cylindrical bottle 153. The dispensing assembly 140 may also be removable and refillable and the dispensing assembly 140 may be contained within confines of the inner-volume 125 of the handle 115. Further, the dispensing assembly 140 may be configured to store aforementioned contents 142 and may be stored with an aerosol propellant.

It is notable that in the preferred embodiment the dispensing assembly 140 is sized to store a volume of up to 3.4 fluid ounces of the contents 142 to meet federal airline safety regulations. Upon reading this specification, it should be appreciated that, under appropriate circumstances, considering such issues as user preferences, design preference, structural requirements, marketing preferences, cost, available materials, technological advances, etc., other shaver-body 110 arrangements such as, for example, different handle configurations, inner volumes, fluid ounce sizes of the contents 142, types of contents 142 etc., may be sufficient.

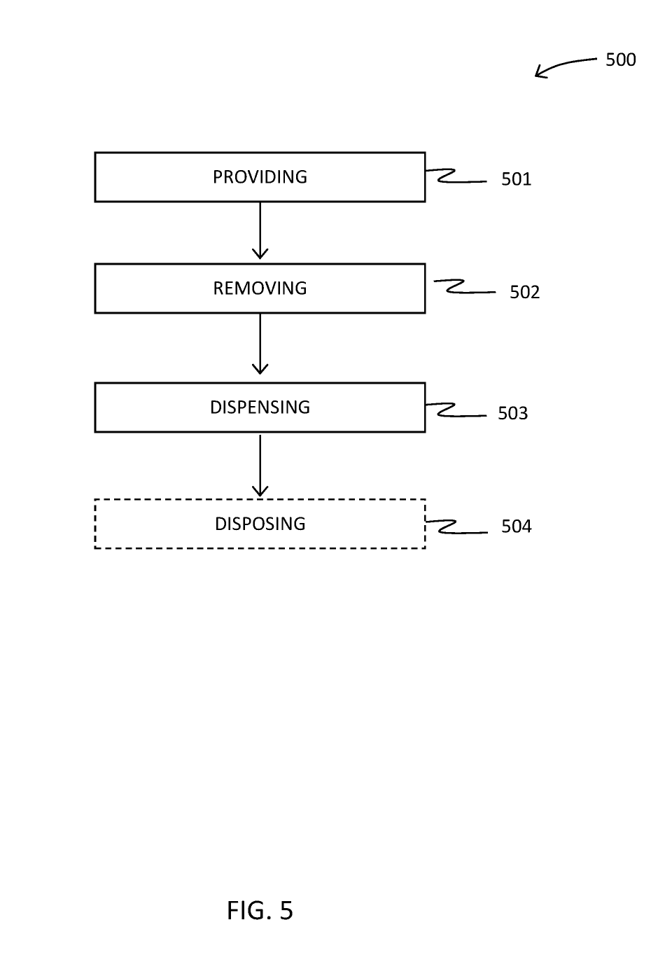

FIG. 5 is a flow diagram illustrating a method for using the disposable shaver system, 500 according to an embodiment of the present disclosure. In particular, the method for disposable shaver system 500 may include one or more components or features of the disposable shaver system 100 as described above. As illustrated, the method for use for the disposable shaver system 500 may include the steps of: step one 501, providing a disposable shaver assembly 140; step two 502, removing a handle 115 closure cap 150; step three 503, dispensing contents 142, the contents 142 comprising shaving cream for use with the disposable shaver assembly 140 for at least one shaving procedure and step four 504, disposing of the disposable shaver assembly 140 when the at least one shaving procedure is completed.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use and manufacture of the disposable shaver system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A disposable shaver system, the system comprising:
a disposable shaver assembly including;
a shaver-body having;
a handle including;
an outer-surface; and
an inner-volume;
a shaver-head having;
an integral blade retainer; and
at least one cutting blade;
a dispensing assembly having;
a dispensing valve; and
a handle closure cap;
wherein said disposable shaver system comprises said disposable shaver assembly;
wherein said disposable shaver assembly comprises said shaver-body;
wherein said shaver-body includes said handle, said shaver-head, said dispensing assembly, and said handle closure cap;
wherein said handle is defined by said outer-surface and said inner-volume;
wherein said shaver-head includes said integral blade retainer and said at least one cutting blade in functional combination;
wherein said dispensing assembly comprises said dispensing valve;
wherein said handle closure cap is removably couplable to said handle to provide access to said dispensing valve when it is desired to dispense contents held within said dispensing assembly;
wherein said at least one cutting blade is mounted in said integral blade retainer;
wherein said dispensing assembly is contained within confines of said inner-volume of said handle; and
wherein said disposable shaver system is configured to provide a compact said disposable shaving system allowing a user to shave using said at least one cutting blade and dispense said contents as needed for shaving.

2. The disposable shaver system of claim 1, wherein said dispensing assembly is removable and refillable.

3. The disposable shaver system of claim 1, wherein said dispensing assembly is non-removable and non-refillable.

4. The disposable shaver system of claim 1, wherein the shaver-head is hingeably-mounted.

5. The disposable shaver system of claim 1, wherein the shaver-head is integral with and fixed to said handle.

6. The disposable shaver system of claim 1, wherein the handle closure cap is threadably-coupleable to said handle.

7. The disposable shaver system of claim 1, wherein the dispensing assembly is configured to store said contents, said contents comprising shaving cream therein and to dispense therefrom via said dispensing valve.

8. The disposable shaver system of claim 7, wherein the shaving cream is stored with an aerosol propellant.

9. The disposable shaver system of claim 1, wherein the dispensing assembly is sized to store a volume of up to 3.4 fluid ounces of said contents.

10. The disposable shaver system of claim 9, wherein the 3.4 fluid ounces of said contents meet federal airline safety regulations.

11. The disposable shaver system of claim 1, wherein the dispensing assembly is configured to store said contents, said contents comprising gel therein and to dispense therefrom via said dispensing valve.

12. The disposable shaver system of claim 1, wherein the dispensing assembly is configured to store said contents, said contents comprising liquid therein and to dispense therefrom via said dispensing valve.

13. The disposable shaver system of claim 1, wherein the dispensing valve comprises a manual pump to dispense said contents.

14. The disposable shaver system of claim 1, wherein the at least one cutting blade is able to be lubricated.

15. The disposable shaver system of claim 1, wherein the dispensing assembly comprises a 3-D cylindrical bottle.

16. The disposable shaver system of claim 1, wherein the handle closure cap is non-threadably-mountable to said handle.

17. A disposable shaver system, the system comprising:
a disposable shaver assembly including;
a shaver-body having;
a handle including;
an outer-surface; and
an inner-volume;
a shaver-head having;
an integral blade retainer; and
at least one cutting blade;
a dispensing assembly having;
a dispensing valve; and
a handle closure cap;
wherein said disposable shaver system comprises said disposable shaver assembly;
wherein said disposable shaver assembly comprises said shaver-body;
wherein said shaver-body includes said handle, said shaver-head, said dispensing assembly, and said handle closure cap;
wherein said handle is defined by said outer-surface and said inner-volume;
wherein said shaver-head includes said integral blade retainer and said at least one cutting blade in functional combination;
wherein said dispensing assembly comprises said dispensing valve;
wherein said handle closure cap is removably couplable to said handle to provide access to said dispensing valve when it is desired to dispense contents held within said dispensing assembly;
wherein said at least one cutting blade is mounted in said integral blade retainer;
wherein said dispensing assembly is contained within confines of said inner-volume of said handle;
wherein said dispensing assembly is removable and refillable;
wherein the dispensing assembly comprises a 3-D cylindrical bottle;
wherein the dispensing assembly is configured to store said contents, said contents comprising shaving cream therein and to dispense therefrom via said dispensing valve;
wherein the dispensing assembly is sized to store a volume of up to 3.4 fluid ounces of said contents;
wherein the 3.4 fluid ounces of said contents meets federal airline safety regulations;
wherein the dispensing valve comprises a manual pump to dispense said contents; and
wherein said disposable shaver system is configured to provide a compact said disposable shaving system allowing a user to shave using said at least one cutting blade and dispense said contents as needed for shaving.

18. The disposable shaver system of claim 17, further comprising set of instructions; and
wherein the disposable shaver system is arranged as a kit.

19. A method of use for a disposable shaver system, the method comprising the steps of:
providing a disposable shaver assembly;
removing a handle closure cap; and
dispensing contents, said contents comprising shaving cream for use with said disposable shaver assembly for at least one shaving procedure.

20. The method of claim 19, further comprising the step of disposing of said disposable shaver assembly when said at least one shaving procedure is completed.
